(19) United States
(12) Patent Application Publication
(10) Pub. No.: US 2013/0061453 A1
(43) Pub. Date: Mar. 14, 2013

(54) Mounting a Base Plate on Upstanding Fasteners of a Support

(71) Applicant: Dean R. Rosendahl, Elie (CA)

(72) Inventor: Dean R. Rosendahl, Elie (CA)

(21) Appl. No.: 13/229,144

(22) Filed: Sep. 9, 2011

(51) Int. Cl. B23P 11/00; B23P 17/00

(52) U.S. Cl. 29/525.11; 29/428

(57) ABSTRACT

In a method for mounting a base plate on upstanding threaded fasteners of for example a cast concrete support there is provided in the base plate a plurality of adjustable disk members each defining an elongate fastening slot therein for receiving a respective one of the threaded fasteners therein at different positions therealong. Each of the adjustable disk members has a circular outer periphery engaging into a respective plate holes such that the adjustable disk member is supported in the base plate. Each of the adjustable disk members is rotated in its respective plate hole relative to the base plate so as to move the fastening slots relative to the base plate so as to match the fixed located positions of the fasteners.

This invention relates to a method for mounting a base plate on upstanding fasteners of a support.

The invention is particularly applicable for mounting a base plate onto upstanding screw fasteners which are cast in a concrete support so that the fasteners stand upwardly from the concrete support for engaging through pre-formed holes in the base plate.

There are at times difficulties in setting bolts or screw fasteners in an exact location in the concrete base to line up and fit with the mounting holes in infrastructure components and to align the component to its desired position.

That is the location of the screw fasteners may not directly align with the holes and when engaged through the holes may not locate the base plate or components carried on the base plate at the exact correct location to match with or cooperate with other components.

### SUMMARY OF THE INVENTION

It is one object of the invention to provide a method for mounting a base plate on upstanding fasteners of a support.

According to one aspect of the invention there is provided a method for mounting a base plate on upstanding threaded fasteners of a support comprising:

locating the plurality of threaded fasteners on a support so as to stand upwardly from the support at fixed locations thereon;

providing a base plate having a plurality of circular plate holes therein for engaging over the fasteners;

providing a plurality of adjustable disk members;

each of the adjustable disk members defining an elongate fastening slot therein for receiving a respective one of the threaded fasteners therein at different positions therealong;

each of the adjustable disk members having a circular outer periphery for engaging into a respective one of the circular plate holes such that the adjustable disk member is supported in the base plate;

each of the adjustable disk members having the fastening slot providing an opening extending through the adjustable disk member substantially at right angles to the base plate;

each of the adjustable disk members being rotatable in its respective plate hole relative to the base plate;

and rotating the adjustable disk members in the plate holes so as to move the fastening slots relative to the base plate so as to match the fixed located positions of the fasteners.

While the concept disclosed herein is primarily designed to be used for mounting items having a plate mounted to the ground or a foundation, there is the possibility for using the same method to mount two beams together or on the side of a post. In this case the term “base plate” and “upstanding” set forth above are to be interpreted broadly and are not intended to be indicative of a specific orientation of the components so that these terms are used for convenience of explanation rather than as a specific limitation to a specific orientation.

Preferably the slot has one end at the center of the adjustable disk member and extends from the center outwardly toward one part of the periphery thereof.

In one arrangement, each of the adjustable disk members has a peripheral lip which sits on a corresponding surface in the respective plate hole to prevent the adjustable disk member from passing through the plate hole. The lip can sit on the top surface of the base plate or in a recess in the base plate.

In another arrangement, each of the adjustable disk members has a peripheral tapered edge which sits in a corresponding tapered edge in the respective plate hole to prevent the adjustable disk member from passing through the plate hole.

In both cases the top surface of the adjustable disk member can be coplanar with the top surface of the base plate or it can stand proud of the base plate.

In most cases, a nut is engaged onto the threaded fastener on top of the adjustable disk member and clamps down into the top surface of the disk member.

In some cases a washer can be engaged over the threaded fastener on top of the adjustable disk member for the nut to be applied onto the top of the washer.

Where a washer is used, each of the adjustable disk members may have a recess therein surrounding the slot so that the washer is received in the recess regardless of the position of the threaded fastener along the slot.

This invention is particularly applicable where the threaded fasteners are cast into a concrete support since they are often inaccurately located. However it can also apply where other forms of fastening to the support are used such as welding.

This invention is particularly applicable where the base plate forms a bottom plate of a post which is upstanding from the support. However it can also be used for example for the bottom panel of a cabinet or the like.

In most cases there will be four threaded fasteners at corners of a rectangle. However other numbers of fasteners can be used.

In a particularly advantageous arrangement, there are two base plates, for separately mounted components mounted onto respective sets of threaded fasteners and the adjustable members allow the horizontal position of one base plate to be adjusted relative to that of the other.

The adjustable disk members thus act as a universal mounting washer. Using a larger hole in the infrastructure component then mating a universal mounting washer to engage the mounting bolts allows flexibility to mount the component when the bolts are out of alignment of the desired bolt pattern. The degree of flexibility is determined with the size of the washer and mounting holes in the infrastructure component.

This also affords a degree of movement in the mounting of components in order for them to line up to other infrastructure components, for example lining up more then one fence post with the others, lining up structural steel for buildings, lining up the first and second leg of an advertising sign.

This method of mounting also increases and allows an infrastructure component to be mounted to larger selection of bolt patterns. i.e. 6-inch pattern or 7-inch pattern by simply rotating the mounting washers to the proper position for fitting each unique mounting condition. This eliminates the need to offer two different mounting options for the infrastructure component thereby easing the installation process and reducing costs.

As a safety feature the mounting washers can be made of a softer material there by becoming the weak point or break point in the event of extreme stress being applied to the infrastructure component, for example impact with a post by a moving vehicle. It should also be noted that the mounting washers can be made of a harder material to ensure they will not fail such as the case might require for building structural applications.

in this case, failure of the mounting washers would release the infrastructure component from the foundation in a controlled action resulting in reduced fatal stresses being applied to the source of the extreme stress. The failure of the slotted mounting washers would increase the possibility of the survival of the foundation mounting bolts thereby making the repair and restoration of the infrastructure component that much easier.

In addition, if a mounting bolt in the foundation does become unusable, a new bolt can be installed at a different location in the foundation, which is still within the mounting washers travel range thereby affecting a repair with ease.

Examples of infrastructure components are, but not limited to, Posts, Fences, Signs, Light Standards, Electrical Posts, Electrical equipment panels.

The method can be used for mounting infrastructure components to foundations most commonly but not limited to, concrete grade beams, slabs, piles, or pillars, which have threaded bolts coming up and out for fastening the infrastructure components to them. This of course does not preclude the possibility of mounting threaded nuts in the foundation and using bolts down and into the foundation.

The universal mounting washer consists of a round stepped or tapered washer with a slot extending from the center out to the inside edge of the step or taper at one location.

The washer is placed in an infrastructure component mounting hole which is round matching the mounting washer, thereby allowing the washer to rotate within the hole 360 degrees, and allowing the stepped section or tapered selection to exert force down on the mounting surface of the component.

This action allows the slot to align perfectly with a mounting bolt location at any location within the circle from the foundation.

Fastening methods can vary, but typically a standard washer can then be installed over the mounting bolt in the case of the bolt protrudes up from the foundation a nut is tightened down over the assembly securing the infrastructure component in place. This of course does not imply that a standard washer is needed in all cases.

Other mounting options could include but not limited to: Nuts with a washer attached; Contoured Nuts, with a radius or chamfer; Standard bolts, with or without standard washers; Flat head screws which have a chamfer engaged in the slotted washers.

This arrangement can be used in conjunction with the post construction shown in U.S. application Ser. No. 12/836,657 filed Jul. 15, 2010, with the electrical systems shown in U.S. Pat. No. 5,521,838 issued May 28, 1996 of Glenn Rosendahl and U.S. Pat. No. 7,642,670 issued Jan. 5, 2010, the disclosures of all of which are incorporated herein by reference.

### BRIEF DESCRIPTION OF THE DRAWINGS

One embodiment of the invention will now be described in conjunction with the accompanying drawings in which:

FIG. 1 is an isometric view of a post being mounted on a concrete cast base using the method according to the present invention.

FIG. 2 is a side elevational view of the post and concrete cast base of FIG. 1.

FIG. 3 is a an isometric view of the post and concrete cast base of FIG. 1 showing a modified embodiment.

FIG. 4 is a top plan view of the post and concrete cast base of FIG. 1.

FIG. 5 is an isometric view of an electrical cabinet being mounted on a concrete cast base using the method according to the present invention.

FIG. 6 is a top plan view of two base plates being mounted on separate concrete cast base using the method according to the present invention for alignment of the base plates.

In the drawings like characters of reference indicate corresponding parts in the different figures.

### DETAILED DESCRIPTION

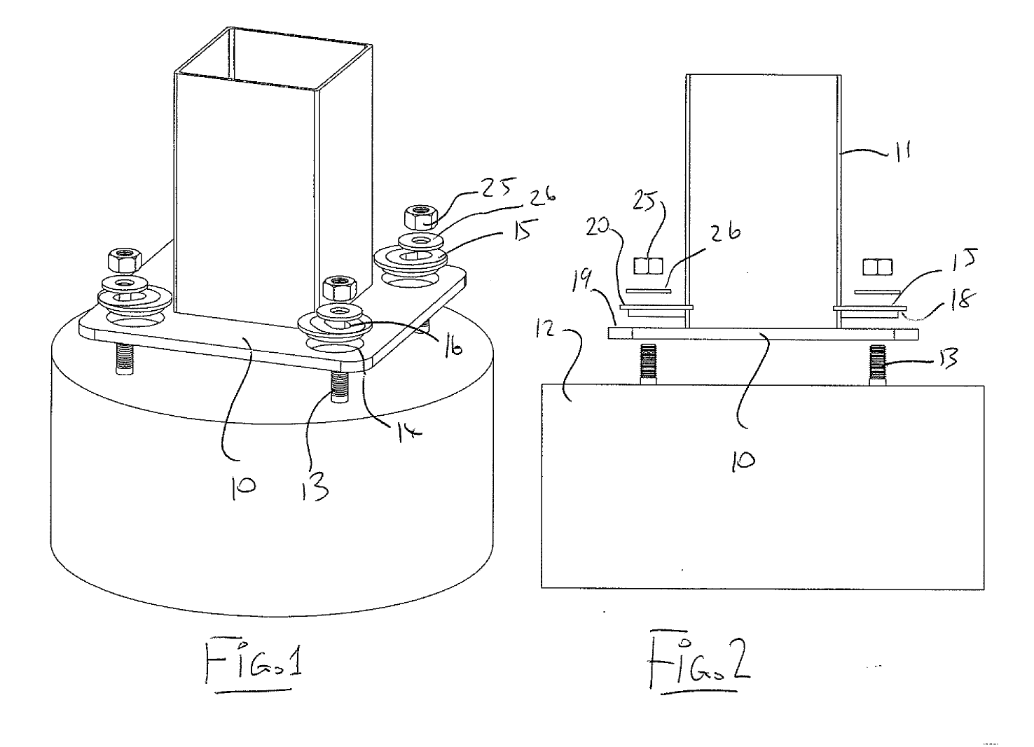

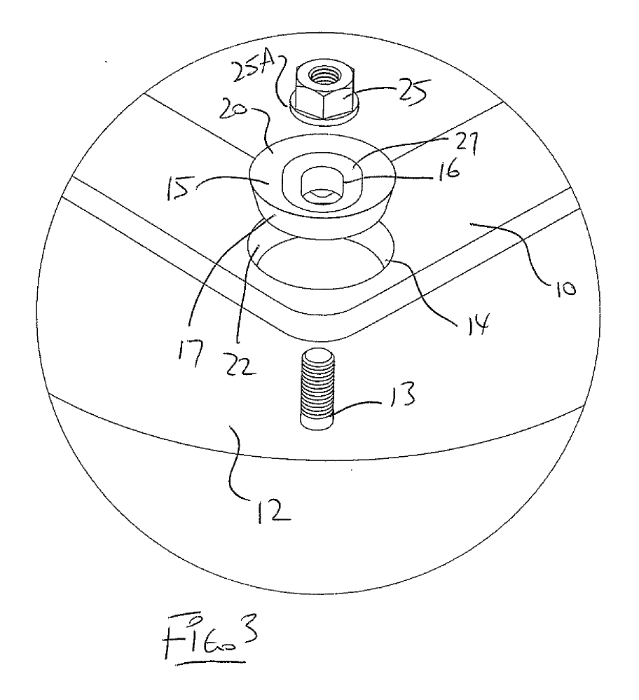

One embodiment of the method of the present invention is shown in FIGS. 1 and 2. This includes a base plate 10 carrying a post 11. The base plate can be of any suitable shape and may be integral or formed in sections. It is in most cases planar but does not have to be. As shown the post 11 is welded to the base plate 10 but other fastening systems may be used.

The base plate is attached to a support 12 which is typically formed of a cast concrete with a plurality of upstanding threaded fasteners 13 cast into the support at spaced positions in an array on the support. As the fasteners 13 are cast in place, they are typically inaccurately located due to casting errors, or require very close attention to provide suitable accuracy.

Thus the plurality of threaded fasteners 14 are located on the support 12 so as to stand upwardly from the support at fixed locations thereon.

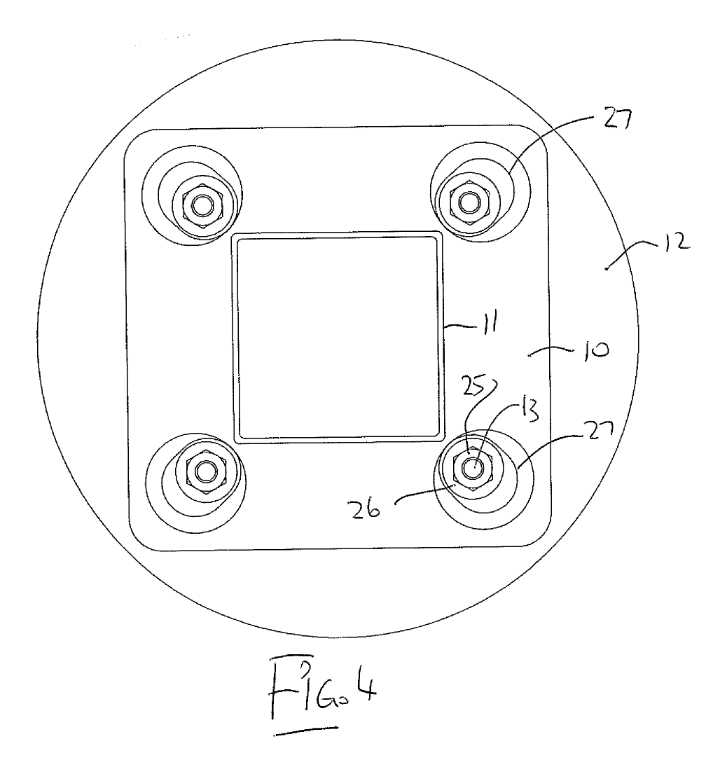

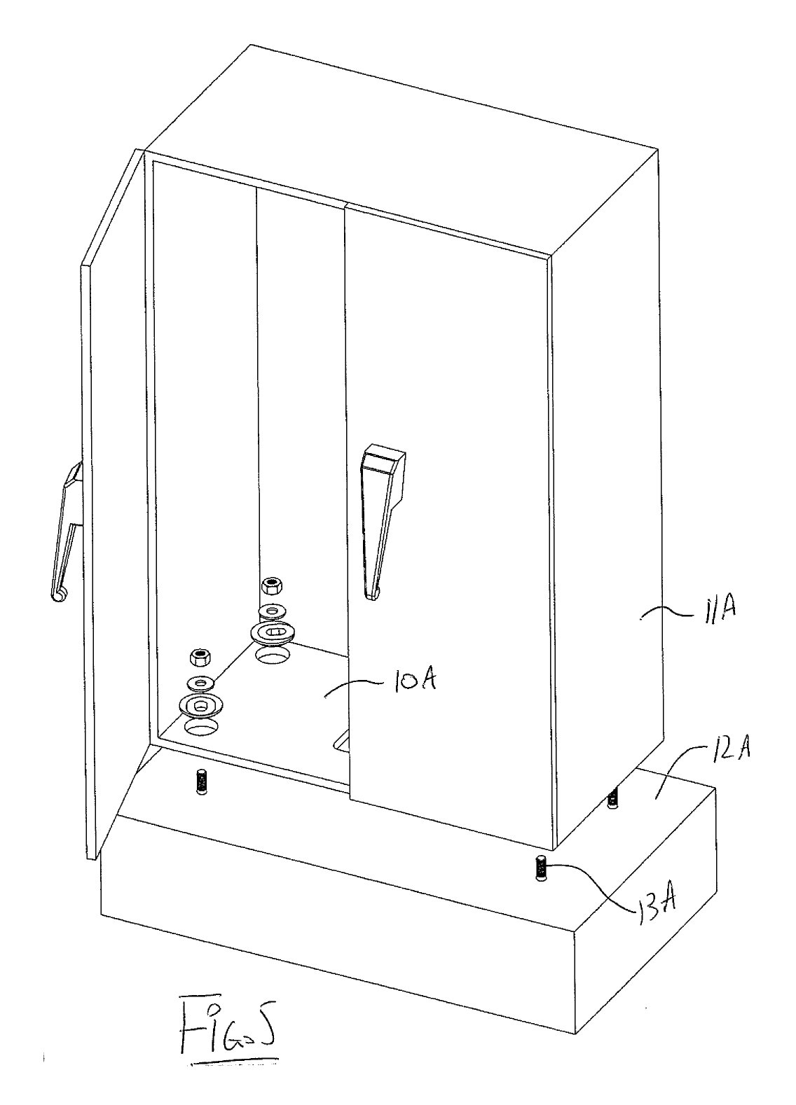

The base plate 10 has a plurality of circular plate holes 14 therein for engaging over the fasteners 13. These holes are associated with a plurality of adjustable disk members 15, each defining an elongate fastening slot 16 therein for receiving a respective one of the threaded fasteners therein at different positions along the slot. That is the slot 16 provides an opening extending through the adjustable disk member substantially at right angles to the base plate. The slot as shown in FIG. 3 has one end at the center of the adjustable disk member 15 so that the fastener when located at this end is central to the circular peripheral wall 17 of the disk 15 and the slot extends from the center outwardly toward one part of the periphery of the disk.

Each of the adjustable disk members 15 having a circular outer periphery 17 for engaging into a respective one of the circular plate holes 14 such that the adjustable disk member is supported in the base plate 10. Each of the adjustable disk members 15 is rotatable in its respective plate hole 14 relative to the base plate 10.

In use the base plate is located over the fasteners and the adjustable disk members are rotated in the plate holes so as to move the fastening slots relative to the base plate so as to match the fixed located positions of the fasteners.

In FIG. 1 and method according to claim 1 wherein each of the adjustable disk members 15 has a peripheral lip 18 defining a bottom shoulder surrounding the disk which sits on a corresponding surface in the respective plate hole to prevent the adjustable disk member from passing through the plate hole. In the embodiment shown the surface of the base plate is the top surface 19 so that a top surface 20 of the disk stands proud of the top surface 19. However the hole 14 can be cut with a recessed shoulder so that the lip 18 sits down inside the hole with the surfaces 19 and 20 coplanar.

In the embodiment of FIG. 3, each of the adjustable disk members has a peripheral tapered edge 17 which gets wider toward the top surface 20 which sits in a corresponding tapered edge 22 in the respective plate hole 14 to prevent the adjustable disk member from passing through the plate hole.

When the disks are adjusted by rotation within the holes so that the fasteners pass through the sots 16, a nut 25 is engaged onto the threaded fastener 13 on top of the adjustable disk member 15. In FIG. 1, an additional washer 26 is engaged over the threaded fastener 13 on top of the adjustable disk member and underneath the nut. In FIG. 3, the nut includes an integral washer 25A which can be a lock washer of conventional construction.

Each of the adjustable disk members 15 has a recess 27 therein surrounding the slot 16 arranged so that the washer 25A is received in the recess 27 regardless of the position of the threaded fastener along the slot.

As shown in FIG. 1, there are typically four threaded fasteners at corners of a rectangle.

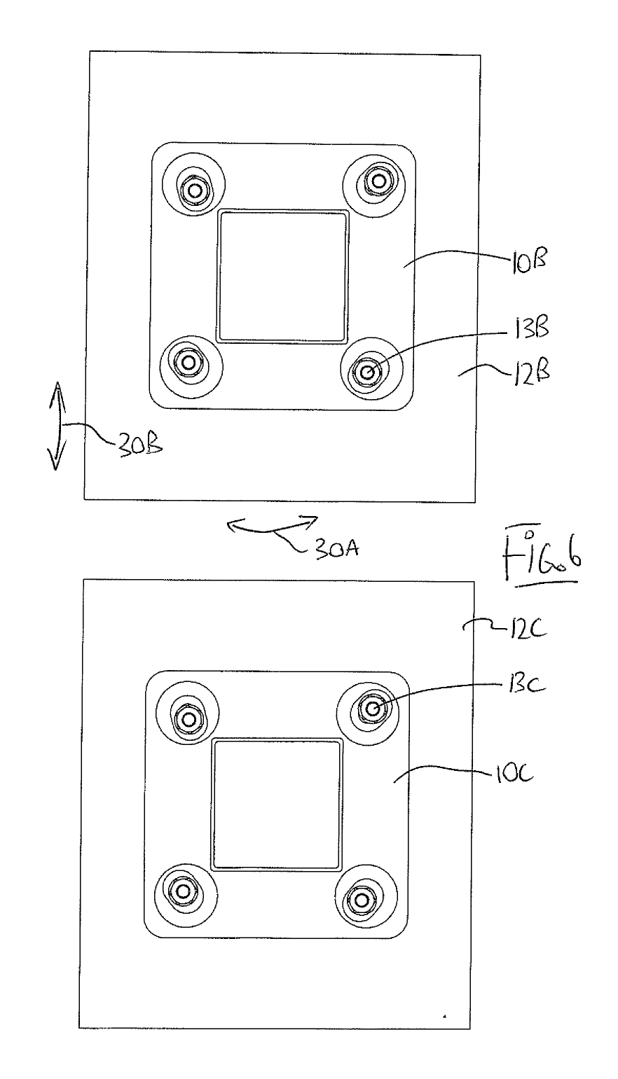

In FIG. 5 is shown an electrical cabinet 11A having a base plate 10A mounted on a concrete cast support 12A by fasteners 13A using the same system as described above.

In FIG. 6 there are two base plates 10b, 10C mounted onto respective sets of threaded fasteners 13B, 13C each carried on a respective support 12B, 12C so that the adjustable disk members 15B, 15C allow the horizontal position of one base plate to be adjusted as shown at 30A and 30B relative to that of the other.

It will be appreciated therefore that by rotating the disc 15 around the axis of the hole 14 and by moving the screw 13 along the slot 16, the screw 13 can be located at any position within an imaginary circle surrounding the axis and within the end of the slot 16. This allows significant adjustment of the base plates 10B, 10C to change the spacing and alignment as required for supporting elements carried by the posts thereon.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method for mounting a base plate on upstanding threaded fasteners of a support comprising:
locating the plurality of threaded fasteners on a support so as to stand upwardly from the support at fixed locations thereon;
providing a base plate having a plurality of circular plate holes therein for engaging over the fasteners;
providing a plurality of adjustable disk members;
each of the adjustable disk members defining an elongate fastening slot therein for receiving a respective one of the threaded fasteners therein at different positions therealong;
each of the adjustable disk members having a circular outer periphery for engaging into a respective one of the circular plate holes such that the adjustable disk member is supported in the base plate;
each of the adjustable disk members having the fastening slot providing an opening extending through the adjustable disk member substantially at right angles to the base plate;
each of the adjustable disk members being rotatable in its respective plate hole relative to the base plate;
and rotating the adjustable disk members in the plate holes so as to move the fastening slots relative to the base plate so as to match the fixed located positions of the fasteners.

2. The method according to claim 1 wherein the slot has one end at the center of the adjustable disk member and extends from the center outwardly toward one part of the periphery thereof.

3. The method according to claim 1 wherein each of the adjustable disk members has a peripheral lip which sits on a corresponding surface in the respective plate hole to prevent the adjustable disk member from passing through the plate hole.

4. The method according to claim 1 wherein each of the adjustable disk members has a peripheral tapered edge which sits in a corresponding tapered edge in the respective plate hole to prevent the adjustable disk member from passing through the plate hole.

5. The method according to claim 1 wherein a nut is engaged onto the threaded fastener on top of the adjustable disk member.

6. The method according to claim 1 wherein a washer is engaged over the threaded fastener on top of the adjustable disk member.

7. The method according to claim 1 wherein each of the adjustable disk members has a recess therein surrounding the slot so that the washer is received in the recess regardless of the position of the threaded fastener along the slot.

8. The method according to claim 1 wherein the threaded fasteners are cast into a concrete support.

9. The method according to claim 1 wherein the base plate forms a bottom plate of a post which is upstanding from the support.

10. The method according to claim 1 wherein there are four threaded fasteners at corners of a rectangle.

11. The method according to claim 1 wherein there are two base plates mounted onto respective sets of threaded fasteners and wherein the adjustable members allow the horizontal position of one base plate to be adjusted relative to that of the other.
